(19) United States
(12) Patent Application Publication
(10) Pub. No.: US 2025/0280251 A1
(43) Pub. Date: Sep. 4, 2025

(54) HEARING AID

(71) Applicant: Oticon A/S, Smørum (DK)

(72) Inventors: Troels Holm PEDERSEN, Virum (DK); Thor Højlund OLSEN, Smørum (DK); Nicolai Domingo NIELSEN, Smørum (DK); Nicolas Kjær HØJFELDT, Smørum (DK); Søren Skall TOKE, Smørum (DK); Anna FLIID, Smørum (DK); Jacob MORTENSEN, Smørum (DK); Christoforos KANAVAKIS, Frederiksberg (DK); Ebbe Jannes LARSEN, Smørum (DK); Karthick VELLAIAPPAN, Smørum (DK); Jens LUNDBY, Smørum (DK); Dmitri RATSKOVSKI, Smørum (DK); Per LUNDBERG, Smørum (DK); Mads Buur MORTENSEN, Smørum (DK); Thorbjørn PASGAARD, Smørum (DK); Konstantinos ANYFANTAKIS, Smørum (DK); Shanchivan RAJALINGAM, Smørum (DK); Lu XIA, Smørum (DK); Jan RYTTER, Smørum (DK); Finn DANIELSEN, Smørum (DK); Svend REINEMO, Smørum (DK); Robert WITVLIET, Smørum (DK); Anders JENSEN, Smørum (DK); Morten VANDBORG, Smørum (DK); Jens TROELSEN, Smørum (DK)

(21) Appl. No.: 19/069,293

(22) Filed: Mar. 4, 2025

(30) Foreign Application Priority Data
Mar. 4, 2024 (EP) 24161188.8

(51) Int. Cl. H04R 25/00

(52) U.S. Cl. CPC H04R 25/652; H04R 25/552; H04R 25/554; H04R 25/602; H04R 2225/023; H04R 2225/51

(57) ABSTRACT

Disclosed herein are embodiments of a hearing aid configured to be positioned in an ear canal of a user. The hearing aid includes a number of different structural sections. In certain examples, a middle section includes a rechargeable battery and a substrate carrying one or more electronic components, where the substrate is constructed as a flexible circuit board arranged at the battery, and where the middle section is at least partially encapsulated by a polymer material.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### FIELD

The present application relates to the field of hearing aids. In particular hearing aids configured to be positioned mostly or entirely in the ear canal of a user. Further, the hearing aid, or parts thereof, may be at least party encapsulated. The hearing aid according to the present disclosure may be shaped with a specific geometry so that is it not adapted specifically to fit in a particular user's ear canal. The hearing aid according to the present disclosure may include an adaptor to act as an interface between the hearing aid and the ear canal of a user. The adaptor may include a soft dome shape or a custom-shaped outer geometry so that the generically shaped hearing aid may be located in the ear canal in a secure way.

The present disclosure generally relates to a hearing aid. The hearing aid may be configured for use in the ear canal. The hearing aid according to the present disclosure may comprise a front section comprising a speaker unit/output transducer. The front section could be called a first section. The front section defines a front section axis, seen along it's extension, preferably so that the front section axis passes through an output opening of the speaker unit/output transducer. The speaker unit, or output transducer, may be configured for delivering sound into the ear canal. The speaker unit may be configured with an opening at a distal end which is intended to be located near or in the direction of the eardrum of the person using/wearing the hearing aid. The hearing aid according to the present disclosure may comprise a middle section wherein a rechargeable battery may be arranged. The middle section may be called a second section. Further, an amplifier may be arranged in or at the middle section. The amplifier may be constructed as, or comprise, a flexible circuit board wrapped around the battery. This may be achieved e.g. by providing a substrate comprising two or more sections, where one section may be arranged at one side or face of the battery, and the other section or sections are arranged at other sides, faces or locations at the battery. The middle section may be at least partially encapsulated by a polymer material. By encapsulating is meant that the material encases the components mentioned, preferably the material is applied to the components in a liquid state and solidified so as to create the encapsulation. Unlike a traditional hearing aid housing, encapsulating does not leave any, or at least not much, air between the component and the material making up the wall (i.e. the encapsulation material). This is contemplated to provide a shielding effect towards the relatively hostile environment of the ear canal for the battery and/or the amplifier. The hearing aid according to the present disclosure may comprise a rear section. At the rear section an antenna may be arranged. The antenna may further provide functions as a pull-out string. This could allow the user of the hearing aid to retract the hearing aid out of the ear canal when desired. The hearing aid according to the present disclosure may be configured so that the middle section extends in a lengthwise direction around an axis between the front section and the rear section. By around is understood that the middle section The front section may be configured so as to have a first angle in relation to the axis, or said in another way the front section defining a front section axis in a lengthwise extension direction of the front section. Often the front section will be oblong and have opening so that an output sound from the front section/speaker unit/output transducer exit from that opening. The opening would then be at a distal end of the front section. The oblong shape of the front section could allow the hearing aid to be placed in the ear canal and that a dome or shell may be attached at the tip of the front section which could help hold/retain the hearing aid in the ear canal.

In a hearing aid as described here, the middle section may have a front part attaching to the front section, and a rear part attaching to the rear section. Axis may then extend between these two in a lengthwise direction as described herein.

Generally, a Cartesian coordinate system for a three-dimensional space consists of an ordered triplet of lines (the axes) that go through a common point (the origin), and are pair-wise perpendicular; an orientation for each axis; and a single unit of length for all three axes. In the present context, when referring to axes, there is referred to a straight line, i.e. a line without bends, extending in space. When mentioning how two axes relate to each other, these axes are not coordinate system axes but straight lines in a Cartesian coordinate system.

Soft and replaceable ear-piece or domes, such as made from silicon, foam or gel are useful in connection with the hearing aid of the present disclosure. The ear piece may be adaptable to the ear canal, thereby no customized earpiece is required. This also increase wearing comfort compared to custom devices due to the shape adaptability and simplifies fitting process for the hearing care professional and the user.

Generally, the hearing aid according to the present disclosure may comprise: (at least) one microphone, amplifier, speaker, battery and an ear interface. One of the at least one microphones may be arranged so as to be facing out of the ear to pick up external sound. Due to the microphone placement in the ear canal, the ears natural anatomy is used for achieving easy localization of sound sources. Structurally, the hearing aid according to the present disclosure comprises 3 parts, namely a front section having a speaker/output transducer configured so as to be facing into the ear canal, the speaker/output transducer may then be surrounded by a soft ear piece touching the ear canal or by a shell or mould, possibly shaped according to the specific shape of the user's ear canal. The front section extends in a longitudinal direction which defines a front section axis. Here the front section preferably has an oblong shape. The hearing aid may further also comprise a mid-section with battery and electronics, including a printed circuit board with various components. The hearing aid may further comprise a rear section facing towards the ear canal opening and may comprise an antenna and may include the at least one microphone. Further microphones may be included in the hearing aid and placed e.g. in a location near the distal end of the output transducer, i.e. facing the ear drum of the wearer during use. A second microphone may be placed near the microphone facing the environment, so that the hearing aid comprises at least two microphones facing the environment and configured to pick up sound from the user's surroundings rather than from the ear canal. This could enable the hearing aid to utilise directionality or other such processing schemes.

The hearing aid according to the present disclosure may be configured so that the first angle is different than/from zero. This implies that the two parts are not simply aligned along the same axis.

The hearing aid according to the present disclosure may be configured so that the front section has a second angle (B) in relation to the axis (A). By this configuration it is possible to arrange the two parts better relative to the ear canal of a (average) user.

The hearing aid according to the present disclosure may be configured so that the second angle (B) is different than zero. By having the second angle being different from zero it is ensured that the two parts are not parallel, and thereby have a better fit into the ear canal of an average user. The angle also helps increase the fit rate of the device.

The hearing aid according to the present disclosure may be configured so that the middle section comprises a first microphone facing outwards to pick up external sound. Additional microphones help signal processing algorithms to improve sound pick of the hearing aid.

The hearing aid according to the present disclosure may be configured so that the middle section comprises a second microphone facing outwards for directionality.

The hearing aid according to the present disclosure may be configured so that the speaker unit comprises an inwards facing microphone facing into the ear canal. Such an inwardly facing microphone may be used to pick up own voice of the user, to detect or measure sound pressure in the ear canal, such as to determine or counter occlusion, or for other purposes.

The hearing aid according to the present disclosure may be configured so that the middle section comprises at least one exposed metal pad for charging. Having one or more charging pads on the device enables contact charging of the hearing aid. Contact charging of a battery in a hearing aid may provide faster charging than wireless charging as there is a reduced risk of hearing the battery by induced currents on the battery.

The hearing aid according to the present disclosure may be configured so that the front section comprises an earpiece attached to the speaker unit. The earpiece may be detachable. The earpiece may be referred to as a dome or ear tip. The earpiece may comprise a stem configured to connect the dome/earpiece to the hearing aid, and a skirt or dome-part configured to engage with/abut the ear canal of the user when the hearing aid is placed in the ear canal.

The hearing aid according to the present disclosure may be configured so that the ear piece is a replaceable ear piece touching the ear canal. The ear piece may comprise a stem and a dome part where the stem is configured to engage with the hearing aid and the dome is configured to engage with the walls of the ear canal of the user.

The hearing aid according to the present disclosure may be configured so that the earpiece is a custom ear mold. A custom mould may enable a more tight fit to the ear canal, thereby reducing leakage of sound which in turn leads to reduced feedback when outputting louder sounds to the user. A custom mould may thus enable a user to receive a higher sound level for compensating for their individual hearing loss.

The hearing aid according to the present disclosure may be configured so that the middle section comprises an accelerometer. An accelerometer may be used for measuring/determining different events, such as a user taping once, twice or more on or near the hearing aid to provide some sort of control input, such as a volume change command, a program change command, power level change command (such as requesting the hearing aid to enter a low power mode, such as flight mode or the like).

The hearing aid according to the present disclosure may be configured so that the front section or middle section comprises a non-contact sensor such as: thermal sensor, gyroscope, and/or PPG, and/or a Galvanic skin response sensor for measuring EEG, EMG, and/or ECG. Such sensors may be used to record or detect physiological signals from the user's body. Such signals may be used to control the hearing aid.

The hearing aid according to the present disclosure may be configured so that the hearing aid further comprises a coil for binaural communication and/or wireless charging. Such a coil may perform both such functions. A further coil may be included, such as a telecoil for picking up baseband modulated signals from a telecoil system.

The hearing aid according to the present disclosure may be configured so that the middle section comprises a flexible joint for adapting to any angling of the user's ear canal. This could be achieved by a soft part interconnecting the middle section to the front section, or alternatively a ball-joint between the two parts.

The hearing aid may be adapted to provide a frequency dependent gain and/or a level dependent compression and/or a transposition (with or without frequency compression) of one or more frequency ranges to one or more other frequency ranges, e.g. to compensate for a hearing impairment of a user. The hearing aid may comprise a signal processor for enhancing the input signals and providing a processed output signal.

The hearing aid may comprise an output unit for providing a stimulus perceived by the user as an acoustic signal based on a processed electric signal. The output unit may a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation, or in a headset configuration).

The hearing aid may comprise an input unit for providing an electric input signal representing sound. The input unit may comprise an input transducer, e.g. a microphone, for converting an input sound to an electric input signal. The input unit may comprise a wireless receiver for receiving a wireless signal comprising or representing sound and for providing an electric input signal representing said sound.

The wireless receiver and/or transmitter may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430 THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortionless response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

Most sound signal sources (except the user's own voice) are located far way from the user compared to dimensions of the hearing aid, e.g. a distance d_{mic} between two microphones of a directional system. A typical microphone distance in a hearing aid is of the order 10 mm. A minimum distance of a sound source of interest to the user (e.g. sound from the user's mouth or sound from an audio delivery device) is of the order of 0.1 m (>10 d_{mic}). For such minimum distances, the hearing aid (microphones) would be in the acoustic near-field of the sound source and a difference in level of the sound signals impinging on respective microphones may be significant. A typical distance for a communication partner is more than 1 m (>100 d_{mic}). The hearing aid (microphones) would be in the acoustic far-field of the sound source and a difference in level of the sound signals impinging on respective microphones is insignificant. The difference in time of arrival of sound impinging in the direction of the microphone axis (e.g. the front or back of a normal hearing aid) is ΔT=d_{mic}/v_{sound}=0.01/343 [s]=29 μs, where v_{sound} is the speed of sound in air at 20° C. (343 m/s).

The hearing aid may comprise antenna and transceiver circuitry allowing a wireless link to an entertainment device (e.g. a TV-set), a communication device (e.g. a telephone), a wireless microphone, a separate (external) processing device, or another hearing aid, etc. The hearing aid may thus be configured to wirelessly receive a direct electric input signal from another device. Likewise, the hearing aid may be configured to wirelessly transmit a direct electric output signal to another device. The direct electric input or output signal may represent or comprise an audio signal and/or a control signal and/or an information signal.

In general, a wireless link established by antenna and transceiver circuitry of the hearing aid can be of any type. The wireless link may be a link based on near-field communication, e.g. an inductive link based on an inductive coupling between antenna coils of transmitter and receiver parts. The wireless link may be based on far-field, electromagnetic radiation. Preferably, frequencies used to establish a communication link between the hearing aid and the other device is below 70 GHZ, e.g. located in a range from 50 MHz to 70 GHz, e.g. above 300 MHz, e.g. in an ISM range above 300 MHz, e.g. in the 900 MHz range or in the 2.4 GHz range or in the 5.8 GHz range or in the 60 GHz range (ISM=Industrial, Scientific and Medical, such standardized ranges being e.g. defined by the International Telecommunication Union, ITU). The wireless link may be based on a standardized or proprietary technology. The wireless link may be based on Bluetooth technology (e.g. Bluetooth Low-Energy technology, e.g. LE audio), or Ultra WideBand (UWB) technology.

The hearing aid may be constituted by or form part of a portable (i.e. configured to be wearable) device, e.g. a device comprising a local energy source, e.g. a battery, e.g. a rechargeable battery. The hearing aid may e.g. be a low weight, easily wearable, device, e.g. having a total weight less than 100 g, such as less than 20 g, such as less than 5 g.

The hearing aid may comprise a ‘forward’ (or ‘signal’) path for processing an audio signal between an input and an output of the hearing aid. A signal processor may be located in the forward path. The signal processor may be adapted to provide a frequency dependent gain according to a user's particular needs (e.g. hearing impairment). The hearing aid may comprise an ‘analysis’ path comprising functional components for analyzing signals and/or controlling processing of the forward path. Some or all signal processing of the analysis path and/or the forward path may be conducted in the frequency domain, in which case the hearing aid comprises appropriate analysis and synthesis filter banks. Some or all signal processing of the analysis path and/or the forward path may be conducted in the time domain.

An analogue electric signal representing an acoustic signal may be converted to a digital audio signal in an analogue-to-digital (AD) conversion process, where the analogue signal is sampled with a predefined sampling frequency or rate fₛ, fₛ being e.g. in the range from 8 kHz to 48 kHz (adapted to the particular needs of the application) to provide digital samples xₙ (or x[n]) at discrete points in time tₙ (or n), each audio sample representing the value of the acoustic signal at tₙ by a predefined number N_{b} of bits, N_{b} being e.g. in the range from 1 to 48 bits, e.g. 24 bits. Each audio sample is hence quantized using N_{b} bits (resulting in 2^{Nb} different possible values of the audio sample). A digital sample x has a length in time of 1/fₛ, e.g. 50 μs, for fₛ=20 kHz. A number of audio samples may be arranged in a time frame. A time frame may comprise 64 or 128 audio data samples. Other frame lengths may be used depending on the practical application.

The hearing aid may comprise an analogue-to-digital (AD) converter to digitize an analogue input (e.g. from an input transducer, such as a microphone) with a predefined sampling rate, e.g. 20 kHz. The hearing aids may comprise a digital-to-analogue (DA) converter to convert a digital signal to an analogue output signal, e.g. for being presented to a user via an output transducer.

The hearing aid, e.g. the input unit, and or the antenna and transceiver circuitry may comprise a transform unit for converting a time domain signal to a signal in the transform domain (e.g. frequency domain or Laplace domain, Z transform, wavelet transform, etc.). The transform unit may be constituted by or comprise a TF-conversion unit for providing a time-frequency representation of an input signal. The time-frequency representation may comprise an array or map of corresponding complex or real values of the signal in question in a particular time and frequency range. The TF conversion unit may comprise a filter bank for filtering a (time varying) input signal and providing a number of (time varying) output signals each comprising a distinct frequency range of the input signal. The TF conversion unit may comprise a Fourier transformation unit (e.g. a Discrete Fourier Transform (DFT) algorithm, or a Short Time Fourier Transform (STFT) algorithm, or similar) for converting a time variant input signal to a (time variant) signal in the (time-)frequency domain. The frequency range considered by the hearing aid from a minimum frequency fₘᵢₙ to a maximum frequency fmax may comprise a part of the typical human audible frequency range from 20 Hz to 20 kHz, e.g. a part of the range from 20 Hz to 12 kHz. Typically, a sample rate fₛ is larger than or equal to twice the maximum frequency fmax, fₛ≥2fₘₐₓ. A signal of the forward and/or analysis path of the hearing aid may be split into a number NI of frequency bands (e.g. of uniform width), where NI is e.g. larger than 5, such as larger than 10, such as larger than 50, such as larger than 100, such as larger than 500, at least some of which are processed individually. The hearing aid may be adapted to process a signal of the forward and/or analysis path in a number NP of different frequency channels (NP≤NI). The frequency channels may be uniform or non-uniform in width (e.g. increasing in width with frequency), overlapping or non-overlapping.

The hearing aid may be configured to operate in different modes, e.g. a normal mode and one or more specific modes, e.g. selectable by a user, or automatically selectable. A mode of operation may be optimized to a specific acoustic situation or environment, e.g. a communication mode, such as a telephone mode. A mode of operation may include a low-power mode, where functionality of the hearing aid is reduced (e.g. to save power), e.g. to disable wireless communication, and/or to disable specific features of the hearing aid.

The hearing aid may comprise a number of detectors or sensors configured to provide status signals relating to a current physical environment of the hearing aid (e.g. the current acoustic environment), and/or to a current state of the user wearing the hearing aid, and/or to a current state or mode of operation of the hearing aid. Alternatively or additionally, one or more detectors may form part of an external device in communication (e.g. wirelessly) with the hearing aid. An external device may e.g. comprise another hearing aid, a remote control, and audio delivery device, a telephone (e.g. a smartphone), an external sensor, etc.

One or more of the number of detectors may operate on the full band signal (time domain). One or more of the number of detectors may operate on band split signals ((time-)frequency domain), e.g. in a limited number of frequency bands.

The number of detectors may comprise a level detector for estimating a current level of a signal of the forward path. The detector may be configured to decide whether the current level of a signal of the forward path is above or below a given (L-) threshold value. The level detector operates on the full band signal (time domain). The level detector operates on band split signals ((time-)frequency domain).

The hearing aid may comprise a voice activity detector (VAD) for estimating whether or not (or with what probability) an input signal comprises a voice signal (at a given point in time). A voice signal may in the present context be taken to include a speech signal from a human being. It may also include other forms of utterances generated by the human speech system (e.g. singing). The voice activity detector unit may be adapted to classify a current acoustic environment of the user as a VOICE or NO-VOICE environment. This has the advantage that time segments of the electric microphone signal comprising human utterances (e.g. speech) in the user's environment can be identified, and thus separated from time segments only (or mainly) comprising other sound sources (e.g. artificially generated noise). The voice activity detector may be adapted to detect as a VOICE also the user's own voice. Alternatively, the voice activity detector may be adapted to exclude a user's own voice from the detection of a VOICE.

The hearing aid may comprise an own voice detector for estimating whether or not (or with what probability) a given input sound (e.g. a voice, e.g. speech) originates from the voice of the user of the system. A microphone system of the hearing aid may be adapted to be able to differentiate between a user's own voice and another person's voice and possibly from NON-voice sounds.

The number of detectors may comprise a movement detector, e.g. an acceleration sensor. The movement detector may be configured to detect movement of the user's facial muscles and/or bones, e.g. due to speech or chewing (e.g. jaw movement) and to provide a detector signal indicative thereof.

The hearing aid may comprise a classification unit configured to classify the current situation based on input signals from (at least some of) the detectors, and possibly other inputs as well. In the present context ‘a current situation’ may be taken to be defined by one or more of
a) the physical environment (e.g. including the current electromagnetic environment, e.g. the occurrence of electromagnetic signals (e.g. comprising audio and/or control signals) intended or not intended for reception by the hearing aid, or other properties of the current environment than acoustic);
b) the current acoustic situation (input level, feedback, etc.), and
c) the current mode or state of the user (movement, temperature, cognitive load, etc.);
d) the current mode or state of the hearing aid (program selected, time elapsed since last user interaction, etc.) and/or of another device in communication with the hearing aid.

The classification unit may be based on or comprise a neural network, e.g. a recurrent neural network, e.g. a trained neural network.

The hearing aid may comprise an acoustic (and/or mechanical) feedback control (e.g. suppression) or echo-cancelling system. Adaptive feedback cancellation has the ability to track feedback path changes over time. It is typically based on a linear time invariant filter to estimate the feedback path but its filter weights are updated over time. The filter update may be calculated using stochastic gradient algorithms, including some form of the Least Mean Square (LMS) or the Normalized LMS (NLMS) algorithms. They both have the property to minimize the error signal in the mean square sense with the NLMS additionally normalizing the filter update with respect to the squared Euclidean norm of some reference signal.

The hearing aid may further comprise other relevant functionality for the application in question, e.g. compression, noise reduction, etc.

The hearing aid may comprise a hearing instrument, e.g. a hearing instrument adapted for being located at the ear or fully or partially in the ear canal of a user, an ear protection device or a combination thereof. A hearing system may comprise a speakerphone (comprising a number of input transducers (e.g. a microphone array) and a number of output transducers, e.g. one or more loudspeakers, and one or more audio (and possibly video) transmitters e.g. for use in an audio conference situation), e.g. comprising a beamformer filtering unit, e.g. providing multiple beamforming capabilities.

In an aspect, use of a hearing aid as described throughout the present description, is moreover provided. Use may be provided in a system comprising one or more hearing aids (e.g. hearing instruments), active ear protection systems, etc., e.g. in handsfree telephone systems, teleconferencing systems (e.g. including a speakerphone), public address systems, karaoke systems, classroom amplification systems, etc.

The present disclosure, in an aspect, provides a hearing aid comprising a first part connected to a second part. The second part includes a battery and a substrate, wherein the substrate carries electronic components. The electronic components are, at least, one or of: sound processor, wireless communication. The second part is preferably encapsulated by a material. The encapsulation provides a barrier for the battery and electronics from ear wax, water etc. so as to improve lifetime of the electronics and/or battery. An antenna is attached to the second part and extends from the second part so that when the hearing aid is placed in the ear canal of the user, the antenna lie in the concha of the person using the hearing aid. The first part and the second part form an angle between them so that the first part will bend in a way similar to the ear canal and thereby be able to lie deeper in the ear canal of the user. A dome or compliant member or even a custom shaped part could be attached to the first part. Such a component is contemplated to both provide a more comfortable fit for the user and increase retention force of the hearing aid in the ear canal so that the hearing aid is less likely to fall out of the ear canal during use. The features described in relation to this aspect can be combined with the features mentioned and described in relation to the other aspects and features disclosed herein.

### A Hearing System:

In a further aspect, a hearing system comprising a hearing aid as described above, in the ‘detailed description of embodiments’, and in the claims, AND an auxiliary device is moreover provided.

The hearing system may be adapted to establish a communication link between the hearing aid and the auxiliary device to provide that information (e.g. control and status signals, possibly audio signals) can be exchanged or forwarded from one to the other.

The auxiliary device may be constituted by or comprise a remote control, a smartphone, or other portable or wearable electronic device, such as a smartwatch or the like.

The auxiliary device may be constituted by or comprise a remote control for controlling functionality and operation of the hearing aid(s). The function of a remote control may be implemented in a smartphone, the smartphone possibly running an APP allowing to control the functionality of the audio processing device via the smartphone (the hearing aid(s) comprising an appropriate wireless interface to the smartphone, e.g. based on Bluetooth or some other standardized or proprietary scheme).

The auxiliary device may be constituted by or comprise an audio gateway device adapted for receiving a multitude of audio signals (e.g. from an entertainment device, e.g. a TV or a music player, a telephone apparatus, e.g. a mobile telephone or a computer, e.g. a PC, a wireless microphone, etc.) and adapted for selecting and/or combining an appropriate one of the received audio signals (or combination of signals) for transmission to the hearing aid.

The auxiliary device may be constituted by or comprise another hearing aid. The hearing system may comprise two hearing aids adapted to implement a binaural hearing system, e.g. a binaural hearing aid system.

### Definitions

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

A ‘hearing system’ refers to a system comprising one or two hearing aids, and a ‘binaural hearing system’ refers to a system comprising two hearing aids and being adapted to cooperatively provide audible signals to both of the user's ears. Hearing systems or binaural hearing systems may further comprise one or more ‘auxiliary devices’, which communicate with the hearing aid(s) and affect and/or benefit from the function of the hearing aid(s). Such auxiliary devices may include at least one of a remote control, a remote microphone, an audio gateway device, an entertainment device, e.g. a music player, a wireless communication device, e.g. a mobile phone (such as a smartphone) or a tablet or another device, e.g. comprising a graphical interface. Hearing aids, hearing systems or binaural hearing systems may e.g. be used for compensating for a hearing-impaired person's loss of hearing capability, augmenting or protecting a normal-hearing person's hearing capability and/or conveying electronic audio signals to a person. Hearing aids or hearing systems may e.g. form part of or interact with public-address systems, active ear protection systems, handsfree telephone systems, car audio systems, entertainment (e.g. TV, music playing or karaoke) systems, teleconferencing systems, classroom amplification systems, etc.

The invention is set out in the appended set of claims.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 schematically shows blocks of a hearing aid,

FIG. 2 schematically shows blocks of a hearing aid with external processing,

FIG. 3 schematically shows a hearing aid as described herein,

FIG. 4 schematically shows a different view of the hearing aid of FIG. 3,

FIG. 5 schematically shows a different view of the hearing aid of FIGS. 3 and 4, and

FIG. 6 schematically shows a hearing aid having an antenna with an overmoulded first section and a thinner second section.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processors (DSPs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing aids. FIG. 1 shows an exemplary block diagram of a hearing device, e.g. a hearing aid (HD), comprising a noise reduction system (NRS) and a hearing aid (audio) processor (HAG) for compensating for a hearing impairment of a user of the hearing device. The hearing device comprises an input unit (IU) for picking up sound Sin from the environment (e.g. by M input transducers, e.g. microphones) and providing a multitude (M, M>1) of electric input signals (S₁, . . . , S_{M}) and a noise reduction system (NRS) for estimating a target signal S in the input sound Sin based on the electric input signals and optionally further information, e.g. a mode control signal (Mode). The mode select input (Mode) may be configured to indicate a mode of operation of the system, e.g. of beamformer(s) of the noise reduction system (NRS) and/or a filter coefficient updating strategy, e.g. depending on whether the target signal is the user's own voice or a target signal from the environment of the user (and possibly to indicate a direction to or location of such target sound source). The mode control signal may e.g. be provided from a user interface, e.g. from a remote control device (e.g. implemented as an APP of a smartphone or similar device, e.g. a smartwatch or the like). The mode control signal (Mode) may e.g. be automatically generated, e.g. using one or more sensors, e.g. initiated by the reception of a wireless signal, e.g. from a telephone. The output of the noise reduction system (NRS) may be an estimate of the user's voice Ŝ_{OV}, or an estimate of a target sound from the environment Ŝ_{ENV}. The hearing device, e.g. a hearing aid, further comprises a (audio) processor (PRO) for applying one or more processing algorithms to a signal of the forward path from input to output, e.g. (as here) to the estimate S of the target signal, provided by the noise reduction system, e.g. in a time-frequency representation (Ŝ(k,n)). This may e.g. enabled by respective analysis filter banks (e.g. forming part of the input unit (IU_{MIC}), possibly together with respective analogue to digital converters, as appropriate) providing each of the electric input signals (S₁, . . . , S_{M}) in a time frequency representation (k,n), k and n being frequency and time indices, respectively. The one or more processing algorithms may e.g. comprise a compression algorithm configured to amplify (or attenuate) a signal according to the needs of the user, e.g. to compensate for a hearing impairment of the user. Other processing algorithms may include frequency transposition, feedback control, etc. The processor (PRO) provides a processed output (OUT) that is fed to a synthesis filter bank (FBS) for conversion from the time-frequency representation (frequency domain) to the time domain. Time domain output signal (out) is fed to an output unit (OU) for conversion to stimuli sₒᵤₜ perceivable by the user as sound (Output sound), e.g. acoustic vibrations (e.g. in air and/or skull bone), the synthesis filter bank (FBS) may be omitted). The target signal may be the user's own voice, and/or a target sound in the environment of the user (e.g. a person (other than the user) speaking, e.g. communicating with the user).

The hearing aid further comprises a configurable signal processor (DSP, e.g. a digital (audio) signal processor), e.g. including a processor for applying a frequency and level dependent gain, e.g. providing hearing loss compensation, beamforming, noise reduction, filter bank functionality, and other digital functionality of a hearing device. The configurable signal processor (DSP) is adapted to access a memory (MEM). The configurable signal processor (DSP) is further configured to process one or more of the electric input audio signals and/or one or more of the directly received auxiliary audio input signals, based on a currently selected (activated) hearing aid program/parameter setting (e.g. either automatically selected, e.g. based on one or more sensors, or selected based on inputs from a user interface). The mentioned functional units (as well as other components) may be partitioned in circuits and components according to the application in question (e.g. with a view to size, power consumption, analogue vs. digital processing, acceptable latency, etc.), e.g. integrated in one or more integrated circuits, or as a combination of one or more integrated circuits and one or more separate electronic components (e.g. inductor, capacitor, etc.). The configurable signal processor (DSP) provides a processed audio signal, which is intended to be presented to a user. The hearing aid further comprises a front-end IC (FE) for interfacing the configurable signal processor (DSP) to the input and output transducers, etc., and typically comprising interfaces between analogue and digital signals (e.g. interfaces to microphones and/or loudspeaker(s)). The input and output transducers may be individual separate components, or integrated (e.g. MEMS-based) with other electronic circuitry.

The hearing device (HD) further comprises an output unit (e.g. an output transducer) providing stimuli perceivable by the user as sound based on a processed audio signal from the processor or a signal derived therefrom.

A hearing device as described herein may comprises an output transducer in the form of a loudspeaker (also termed a ‘receiver’) (SPK) for converting an electric signal to an acoustic (air borne) signal, which (when the hearing device is mounted at an ear of the user) is directed towards the ear drum (Far drum), where sound signal (S_{ED}) is provided. The hearing aid or device further comprises a guiding element, e.g. a dome, (DO) for guiding and positioning the hearing aid in the ear canal (Far canal) of the user. The hearing aid may further comprise a further (first) input transducer, e.g. a microphone (M_{ITE,env}), facing the environment for providing an electric input audio signal representative of an input sound signal (SITE) at the ear canal. The hearing aid may further comprise a further (second) input transducer, e.g. a microphone (M_{ITE,ed}), facing the eardrum for providing an (second) electric input audio signal representative of the sound signal (S_{ED})=S_{dir}+S_{HI}) at the eardrum. Propagation of sound (S_{ITE}) from the environment to a residual volume at the ear drum via direct acoustic paths through the semi-open dome (DO) (often denoted Direct path sound). The directly propagated sound is mixed with sound from the hearing device (HD) to a resulting sound field at the ear drum. The sound output SHI of the hearing device may (at least in a specific mode of operation) be modified in view of the directly propagated sound from the environment to the ear drum to provide adaptive noise cancellation (ANC) and/or adaptive occlusion control (AOC).

Apart from the (acoustic) output and input transducers, the hearing aid may further comprise other functional components, e.g. (further) detectors, such as electrodes for picking up signals from the user's body (such as brainwave signals, temperature indications, blood-related parameters, heartbeat indications, muscular vibrations, etc.). Such detectors may include one or more of an electroencephalography (EEG) sensor, an electromyography (EMG) sensor, a movement sensor, a temperature sensor, a photoplethysmography (PPG) sensor, an electrooculography (EOG) sensor, etc.

The electric input signals (from (first and/or second) input transducers M_{BTE1}, M_{BTE2}, M_{ITE,env}, M_{ITE,ed}) may be processed in the time domain or in the (time-)frequency domain (or partly in the time domain and partly in the frequency domain as considered advantageous for the application in question).

The embodiments of a hearing device (HD), e.g. a hearing aid, exemplified in FIG. 1 is a portable device comprising a battery (BAT), e.g. a rechargeable battery, e.g. based on Li-Ion battery technology, e.g. for energizing electronic components of the hearing aid. In an embodiment, the hearing device, e.g. a hearing aid, is adapted to provide a frequency dependent gain and/or a level dependent compression and/or a transposition (with or without frequency compression) of one or more frequency ranges to one or more other frequency ranges, e.g. to compensate for a hearing impairment of a user.

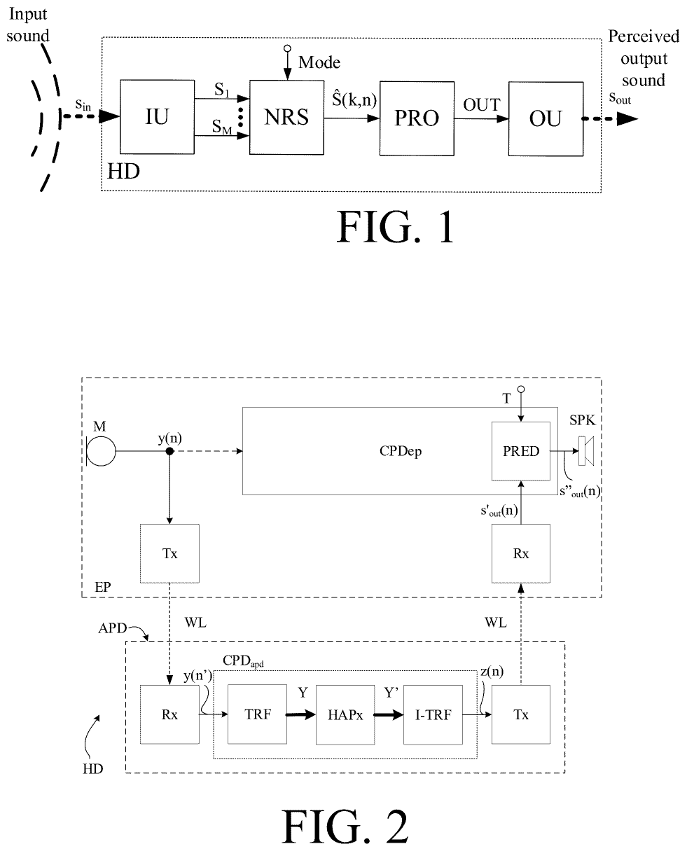

FIG. 2 shows an embodiment of a hearing device (HD), e.g. a hearing aid, configured to be worn at or in an ear of a user and a separate, external, possibly body-worn, audio processing device (APD) configured to be worn or carried by the user (or at least located sufficiently close to the user to stay in communication with the earpiece via a wireless link (WL) implemented by transceivers (Tx/Rx) of the respective devices). The processing device (APD) comprises a computing device (CPD_{apd}, e.g. an audio signal processor or similar.

The hearing device comprises an (at least one) input transducer (here a microphone (M) for converting sound in the environment of the hearing device to an acoustically received electric input signal (y(n)) representing the sound (n indicating a possible time variance). The hearing device further comprises a wireless transmitter (Tx) for transmitting the acoustically received electric input signal (y(n)) or a part (e.g. a filtered part, e.g. a lowpass filtered part) thereof, to the audio processing device (APD). The hearing device further comprises a wireless receiver (Rx) for receiving a processed signal (z(n)) from the audio processing device, at least in a normal mode of operation of the hearing device. The wireless transmitter and receiver (Tx, Rx) may be provided as antenna and transceiver circuitry for establishing an audio communication link (WL) according to a standardized of proprietary (short range) protocol. The hearing device further comprises an output transducer (here a loudspeaker (SPK)) for converting a (final) processed signal (s′ₒᵤₜ(n)) to stimuli perceived by the user as sound.

The processed signal (s′ₒᵤₜ(n)) may, at least in a normal mode of operation of the hearing device, be constituted by or comprise at least a part processed signal (z(n)) provided by the audio processing device. The processed signal (s′ₒᵤₜ(n)) may alternatively (or in a separate (‘stand alone’) mode be constituted by a processed signal provided by the earpiece itself (in which case it may include appropriate processing capacity for processing the electric input signal (y(n)) and providing the processed signal (s′ₒᵤₜ(n)) to the output transducer (SPK)). The optional processing of the acoustically received signal (y(n)) may e.g. be of interest in a mode of operation, where no contact to the audio processing device (APD) can be established (e.g. to provide the user with basic functions of the hearing device (e.g. hearing loss compensation)).

The audio processing device (APD) comprises a wireless receiver (Rx) for receiving the acoustically received electric input signal y(n), or a part thereof, from the earpiece (EP), and is configured to provide a received signal y(n) representative thereof. The audio processing device (APD) (e.g. the computing device (CPD_{apd})) further comprises a (hearing aid) processor part (HAP) for applying a processing algorithm (e.g. including a neural network) to said received signal (y(n)), or to a signal originating therefrom, e.g. a transformed version thereof (Y, e.g. provided by transform unit (TRF), e.g. a Fourier transform unit), and to provide a modified signal (Y′). The processor part (HAP) may e.g. be configured to compensate for a hearing impairment of the user (e.g. by applying a compressive amplification algorithm, e.g. providing a frequency and/or level dependent gain (or attenuation) to be applied to the input signal (y′(n), or Y). In the embodiment of FIG. 2, the audio processing device (APD) (e.g. the computing device (CPD_{apd})) comprises respective transform domain and inverse transform domain units (TRF, I-TRF) to convert a signal in the time domain (here the received signal (y′(n) from the earpiece) to a transform domain (e.g. the time-frequency domain), cf. signal Y, and back again (here the processed signal Y′ in the transform domain to z(n) in the time domain).

The signals transmitted from the hearing device to the (external) audio processing device (APD), via the wireless link (WL), and/or from the audio processing device (APD) to the hearing device, do not necessarily have to be ‘audio signal(s)’ as such. It may as well be features derived from the audio signal(s). E.g. instead of transmitting an audio signal back to the hearing device, a gain derived from the predicted signal could be transmitted back to the earpiece and applied to an appropriately processed (e.g. delayed) version of the electric input signal y(n)).

The term ‘or a processed version thereof’ may e.g. cover such extracted features from an original audio signal. The term ‘or a processed version thereof’ may e.g. also cover an original audio signal that has been subject to a processing algorithm that applies gain or attenuation and/or delay to the original audio signal and this results in a modified audio signal (preferably enhanced in some sense, e.g. noise reduced relative to a target signal, or simply delayed).

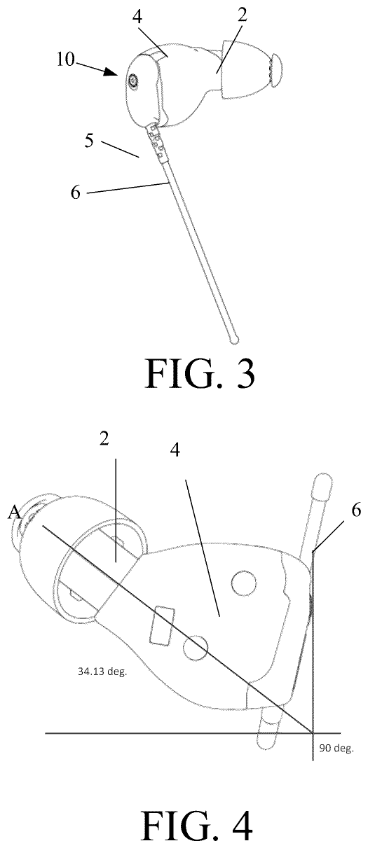

FIG. 3 schematically illustrates a hearing device according to the present disclosure.

The hearing device (10) comprises a front section (2). The front section is configured to be inserted into the ear canal of a user. The front section (2) comprises a speaker unit/output transducer (3) for delivering sound into the ear canal of the user. The front section extends in a longitudinal direction which defines a front section axis. Here the front section has an oblong shape.

Here the front section (2) is provided with a dome or earpiece (11). The dome provides an interface to the ear canal of the user. The earpiece or dome (11) is a replaceable earpiece, which during use will be (at least partly) touching the ear canal. The outer part of the dome is soft so that it will (at least partly) conform to the shape of the ear canal when the hearing device (10) is inserted into the ear canal. The dome (11) further provides a retention force so that the hearing device (10) does not simply slip out of the ear canal. The dome or earpiece (11) is attached to the front section of the hearing aid. In a not-shown alternative, the earpiece (11) may be constituted by a custom ear mold. Such a mold has an outer surface which is substantially shaped according to (a part of) the specific user's ear canal. The custom mold may provide the possibility to provide a higher sound pressure to the user's ear with a reduced risk of feedback compared to when the hearing aid is provided with a (soft) dome at the same sound level. The dome (11) comprises a harder stem which is configured to attach to an attachment point or area at the tip/end of the hearing device where the output transducer is located.

The hearing device (10) comprises a middle section (4) comprising a rechargeable battery and an amplifier or amplifier section. The amplifier section is constructed, or comprises, a (possibly flexible) circuit board at least partly wrapped around a part of the battery. Such as arranged at, along or parallel to, two or more sides of the battery. The circuit board may comprise several sections, where one such section is arranged at one side of the battery, another section at another side of the battery etc. Two of such multiple sections may be connected via a flexible part, or flexible section, where the two sections themselves may be harder or less flexible. A flexible section may be achieved by a different substrate or by establishing a thinner part of the substrate. The middle section of the hearing device is at least partially encapsulated by a polymer material. This provides a protective barrier for the battery and amplifier towards the environment of the hearing device and at the same time provides mechanical stability to the hearing instrument. The substrate may carry one or more electronic components, such as sound processor, wireless interface, filters, decoupling elements, processor for sensors, etc., The wireless interface may provide encoding and decoding used during wireless communication.

The hearing device (10) comprises a rear section (5) comprising an antenna (6). The antenna (6) could be said to constitute the rear section (5). As is seen in figures, the antenna (6) is attached so that the antenna (6), middle section and front section together form the hearing aid. The antenna (6) is attached at the rear section and may be detached therefrom. The antenna (6) has a further function as a pull-out string, meaning that the user may grab on to the antenna and pull it so that the hearing device dislodges from the ear canal and is removed therefrom.

At the point where the antenna (6) is attached to the hearing aid (10), a cap or lid may be placed. The lid or cap may then cover the area where the antenna is attached, such as soldered, to a connector or pin. This pin or connector is further soldered to the substrate on the other side. This establishes an electrical connection between the antenna and the substrate/electronics/transceiver. The transceiver/radio is configured to communicate with external devices via the antenna. Different communication protocols could be implemented via the radio, such as Bluetooth, BLE, Auracast or the like.

The antenna is flexible meaning that it is configured to conform to the shape of a user's ear when the hearing aid is in position in the ear canal of the user. The antenna will retain a part of the shape it will be bent into when the hearing aid is placed in the ear canal of the user, so that the antenna, over time, will be more individually shaped and will then be less noticeable by the user as less force is applied to the ear/concha when the hearing aid is placed in the ear canal.

As illustrated in FIG. 4, the middle section (4) extends in a lengthwise direction around, or along, an axis (A) between the front section (2) and the rear section (5). Around in this context may be taken to mean along the axis or enclose a part of the axis, meaning that the middle section extends along the axis and the axis pass through the middle section (4), as illustrated in FIG. 4. As illustrated in FIG. 4, the front section has a first angle (a) in relation to the axis (A) of 34.13 degrees. The first angle (a) is measured or determined relative to the longitudinal extension of the front section, which define the line A in FIG. 4. This angle may be different in different versions of the hearing aid. Generally, it has been found that the angle may preferably be in the range 10 to 40 degrees, such as in the range of 20 to 35 degrees, such as around 35 degrees.

As seen in FIG. 4, the middle section (4) comprises at least one exposed metal pad (10) for charging. Specifically, as seen in FIG. 4, the hearing aid 10 comprises two charging pads. The two charging pads are arranged on the same side or surface of the hearing aid, and not at opposite or adjoining sides. Here both charging pads are located on the same side of the middle section (4). This allows the hearing aid (10) to be charged in a changer when lying down on one side. Charging through exposed metal pads enables a reduction in size of the instrument, and enables higher charging efficiency, e.g. by allowing faster charging. Such as more than 1C charging (>20 mA).

The hearing aid (10) further comprises a magnet arranged at a side so that when the hearing aid (10) is placed in a charger, the magnet helps align the hearing aid (10) relative to the charger so that efficient electrical connections are established to the metal pads. Misalignment of the metal pad relative to the corresponding charger pins in the charger would reduce the efficiency of the charging process. A metal plate may also be incorporated in the hearing aid so that a corresponding magnet in the charger could be arranged to establish an attraction force to attract the metal plate. The metal plate/magnet combinations provide a force so that the hearing aid is pressed towards the charger surface and thereby increased contact force between the charger pads in the hearing aid and charger pins in the charger.

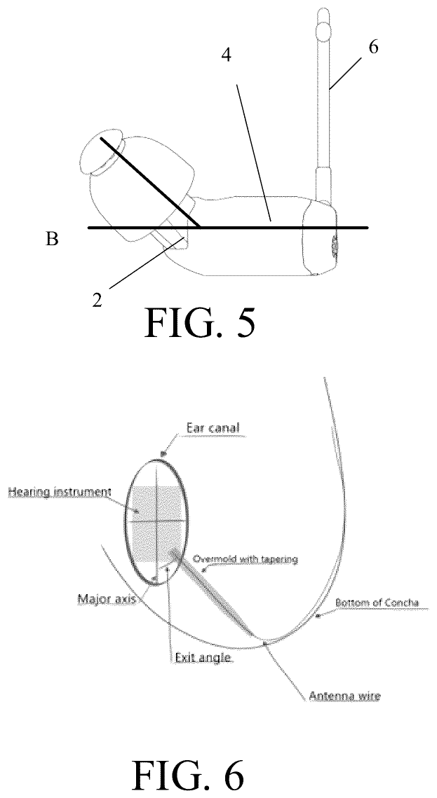

In FIG. 5 it is also shown that the middle section (4) extends along, or around, the axis B. In FIG. 5 the hearing aid (10) is seen from a different angle, and here it possible to see that the receiver in front section (2) has a second angle, here the second angle is 43.72 deg., around the second axis (B), which help the hearing aid to accommodate the relative shape of the ear canal. The second angle could be measured relative to the the axis (A). As seen in the figure, the second angle (B) is different from zero.

The middle section (4) comprises a first microphone (7) facing outwards to pick up external sound. As shown in FIG. 3, the first microphone may be placed at a side area of the end face of the middle section (4).

Although not illustrated, the middle section (4) may be configured to comprise a second microphone facing outwards for directionality. The second microphone may be arranged near the first microphone. The first and second microphone may be arranged so to (substantially) be on a horizontal line when the hearing aid is positioned in the ear canal of a user. This could help improve the signal processor to establish a directional signal.

Although not illustrated, a microphone which may be arranged near the speaker unit (3), i.e. in the front section, so as to be facing into the ear canal, i.e. an inwardly facing microphone. The inwardly facing microphone may be constituted by an accelerometer where the signal therefrom is processed so as to detect own voice from the user or other sounds present in the space between the hearing aid/dome and the ear drum. The signal from the inwardly facing microphone may be used to counter occlusion. The inwardly facing microphone may face the ear canal wall instead of towards the ear drum.

The hearing aid may be provided with an accelerometer. Such accelerometer may be placed in the middle section (4), possibly along with other electronic components on a substrate.

In the front section (2) or middle section (4) of the hearing aid, a non-contact sensor may be provided. Suitable sensors include one or more sensors such as: thermal sensor, gyroscope, and/or PPG, and/or a Galvanic skin response sensor for measuring EEG, EMG, and/or ECG. Depending on the desired physiological value to monitored or determined, a suitable sensor may be chosen. If several sensors are present in the hearing device, one or a number of them can be selectively activated for one or more measurements.

Although not shown, the hearing aid according to the present disclosure may include, at or in the middle section, a flexible joint for adapting to angling of the user's ear canal. This could be a ball-joint or a soft section or connection such as in a different material, so that the two parts may (slightly) adjust relative to each other in order to achieve a more comfortable fit for the user.

For the hearing aids disclosed herein, one aim is to provide an instant-fit completely-in-canal hearing aid that provides immediate custom fitting experience. For the hearing aid as disclosed, the hearing aid wearer does not have to sacrifice size for performance in their hearing aid. The ready-to-wear completely-in-canal (CIC) device may include the following key features:
Full discreteness, due to small size and location in the ear canal,
Rechargeable battery
2.4 Ghz Bluetooth wireless connectivity.
Wireless/inductive communication between 2 hearing instruments.
Build-in accelerometer for tapping, and other future uses

The hearing aid allows for an immediate and hassle-free fit, without the wait times typical of other custom-fit hearing aids. From a hearing care professional's point of view, the hearing aid's fitting process is similar to a RITE instrument currently on the market. The retention of the hearing aid in the ear canal is accomplished with a dome or a custom earmold shell, and hearing instrument may use an interface for this. To achieve a high fit rate, the hearing aid aims to be as small as possible. The thin wall thickness is achieved through epoxy potting technology, which encapsulates internal electronic components, eliminating the need for traditional plastic enclosures. The amplifier comprises a flexible circuit board which is wrapped around the battery to minimize the over-all size of the hearing aid. ‘Wrapping around the battery’ is here to be understood as parts of the flexible circuit board being shaped, such as bend, and positioned in close proximity of the battery so that two or more parts of the flexible circuit board is close to different sides of the battery. Flexible circuit bord does not necessarily mean that the entire substrate is flexible, but that the substrate making up the flexible circuit bord, is able to bend or fold in at least the zones or areas where needed so as to wrap the flexible circuit board around the battery. The hearing aid is to be placed in the ear canal and connectivity is achieved by placing the antenna in the outer ear. The antenna also acts as a pull string. The microphone inlet faces outward from the ear and picks up external sound.

The angle, tilt and height have impact on fit rate based on the variations of ear canals and bends. The optimum angle is depending on the length, width, and height of instrument before and after the angle. When the hearing instrument's body, receiver housing or the earpiece change dimensions, the angle, tilt, height of receiver and fit rate should be reevaluated. Receiver may be angled around 20 to 40 degrees, such as around 25 to 35 degrees, such as around 34.5 degrees, around first axis relative to the insertion side to accommodate after the first bend in the ear canal. Receiver may be angled around 20 to 50 degrees, such as 30 to 45 degrees, such as around 45 degrees around the second axis to accommodate the relative shape of the ear canal.

The antenna may be provided with a first section having a first thickness and followed by a second section having second, smaller, thickness. This could help keep the antenna at a minimum distance from the concha when the device is inserted into an ear canal of a user. The thickness could be tapering so that the transition from the first thickness to the second thickness is gradually reduced over a length of the antenna. The larger thickness of the antenna, such as the antenna having a larger thickness at the section nearest the attachment point of the antenna to the hearing aid body/housing, helps keep a minimum distance for the antenna to the concha/skin of the user's ear. Also, the increase in rigidity help keep the antenna in a predefined orientation relative to the ear canal, and the reduced rigidity help the antenna conform to the shape of the concha where the antenna end will be located during the period when the hearing aid is worn by the user.

FIG. 6 schematically shows a hearing aid having an antenna with an overmoulded first section and a thinner second section. The section nearest the hearing aid housing/body is overmoulded and have at least a partially a tapering shape. The first section exits the housing at an exit angle. The ear canal has substantially an oval shape having a major and a minor axis. The hearing instrument does not fill out the entire ear canal so that it does not block the ear canal. The antenna is deflected/turned when contacting the bottom of the concha.

The hearing aid according to the present disclosure, and as e.g. illustrated in FIG. 6, may be configured so that the transition from the first thickness to the second thickness is tapering over a length of the antenna. The first part of the antenna, i.e. the part that is attached to the body/housing of the hearing aid, may have a first thickness, and a following, second, part of the antenna may have a second, smaller, thickness. The first part of the antenna, owing to the larger thickness, will be stiffer than the second part of the antenna. The first part of the antenna may then maintain its shape better than the second part. The first part of the antenna should still be able to be deform so that it will conform to the concha if the concha is close to the antenna. However, the increased thickness will ensure that there is a minimum distance between the antenna and the concha/skin. The minimum distance will help increase the performance of the antenna, such as due to a lower coupling between the antenna and the skin/ear/head of the user.

It is intended that the structural features of the devices described above, either in the detailed description and/or in the claims, may be combined with steps of the method, when appropriately substituted by a corresponding process.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening element may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method are not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

### REF NUMBERS

Hearing aid 1
Front section 2
Speaker unit 3
Middle section 4
Rear section 5
Antenna 6
First microphone 7
Second microphone 8
Inwards facing microphone 9
Metal pad 10
Dome or Earpiece 11
Axis (A)
Second axis (B)
First angle (a)
Second angle (B)

1. A hearing aid configured to be positioned in an ear canal of a user, the hearing aid comprising;
a front section comprising an output transducer configured to deliver a sound signal, the front section being configured to be positioned into the ear canal of the user, the front section defining a front section axis in a lengthwise direction of the front section,
a rear section comprising an antenna,
a middle section comprising a rechargeable battery and a substrate carrying one or more electronic components, wherein the substrate is arranged at the battery, and wherein the middle section is at least partially encapsulated by a polymer material, and
wherein the middle section extends in a lengthwise direction and defines an axis between the front section and the rear section, and
wherein the front section axis has a first angle different from zero in relation to the axis.

2. The hearing aid according to claim 1, wherein the antenna in the rear section is attached to an outer surface configured to face away from the ear canal of the user when being worn.

3. The hearing aid according to claim 1, wherein the front section has a second angle in relation to the axis.

4. The gearing aid according to claim 3, wherein the second angle is different than zero.

5. The hearing aid according to claim 1, wherein the middle section comprises a first microphone facing outwards of the ear canal to pick up external sound.

6. The hearing aid according to claim 5, wherein the middle section comprises a second microphone facing outwards, and wherein the hearing aid is configured to establish a directional signal based on signals from the first and the second microphones.

7. The hearing aid according to claim 1, wherein the front section comprises an inwards facing microphone configured to facing into the ear canal.

8. The hearing aid according to claim 1, wherein the middle section comprises at least one exposed metal pad configured to receive a charging signal from a charger unit.

9. The hearing aid according to claim 1, wherein an earpiece or dome is releasably attached to the front section comprises.

10. The hearing aid according to claim 9, wherein the earpiece is a replaceable earpiece configured to touch the ear canal when the hearing aid is placed in an ear canal.

11. The hearing aid according to claim 9, wherein the earpiece is a custom ear mold.

12. The hearing aid according to claim 1, wherein the middle section comprises an accelerometer.

13. The hearing aid according to claim 1, wherein the front section or middle section comprises a non-contact sensor such as: thermal sensors, gyroscope, and/or PPG, and/or a Galvanic skin response sensor for measuring EEG, EMG, and/or ECG.

14. The hearing aid according to claim 1, wherein the hearing aid further comprises a coil for binaural communication and/or wireless charging.

15. The hearing aid according to claim 1, wherein the middle section comprises a flexible joint for adapting to any angling of the user's ear canal.

16. A hearing aid configured to be positioned in an ear canal of a user, the hearing aid comprising;
a first section comprising an output transducer configured to deliver a sound signal, the first section being configured to extend into the ear canal of the user, the first section defining a first axis in a lengthwise direction of the first section, a second section comprising a rechargeable battery and a substrate carrying one or more electronic components, wherein the substrate is arranged at the battery, and wherein the second section is at least partially encapsulated by a polymer material, and
wherein the second section extends in a lengthwise direction and defines a second axis between the front section and the rear section, and wherein the first axis has a first angle different from zero in relation to the second axis,
an antenna attached to the second section.

17. The hearing aid according to claim 16, wherein the antenna is configured to extend from the second section into the concha of the ear of the user and abut the concha when the hearing aid is mounted in the ear canal.
